(19) United States
(12) Patent Application Publication
(10) Pub. No.: US 2025/0061544 A1
(43) Pub. Date: Feb. 20, 2025

(54) APPARATUS AND METHOD FOR ENHANCING A WHITEBOARD IMAGE

(71) Applicant: CANON U.S.A., INC., MELVILLE, NY (US)

(72) Inventors: Hung Khei Huang, Irvine, CA (US); Bradley Scott Denney, Irvine, CA (US)

(21) Appl. No.: 18/721,111

(22) PCT Filed: Dec. 19, 2022
(86) PCT No.: PCT/US2022/081936

§ 371 Date: Jun. 17, 2024

Related U.S. Application Data
(60) Provisional application No. 63/291,650, filed on Dec. 20, 2021.

(51) Int. Cl. G06T 5/50; G06T 5/20; G06T 5/80; H04N 1/60

(52) U.S. Cl. CPC G06T 5/50; G06T 5/20; G06T 5/80; H04N 1/6002; G06T 2207/20221

(57) ABSTRACT

An image processing apparatus is provided and includes one or more processors and one or more memories storing instructions that, when executed, configures the one or more processors, to receive a captured video from a camera capturing a meeting room, extract and store a predefined region of the video as extracted image data, generate a first corrected image by performing first image correction processing on the extracted image data to correct noise and generate a binary mask of the first corrected image, generate a filtered image based on the binary mask of the first corrected image and the first corrected image, generate a second corrected image by performing second image correction processing on the filtered image; and perform blending processing that combines the second corrected image with the first corrected image to generate a final corrected image.

### CROSS-REFERENCE TO RELATED APPLICATIONS

This application claims priority from U.S. Provisional Patent Application Ser. No. 63/291,650 filed on Dec. 20, 2021, the entirety of which is incorporated herein by reference.

### BACKGROUND

### Field

The disclosure relates to image processing techniques.

### Description of Related Art

In a meeting room or conference center, there are generally writing surfaces upon which meeting participants are able to write using writing instruments and which allow the participant to view information that one or more participants believe is important. One such writing surface is a whiteboard and participants are able to write on the whiteboard with, for example, erasable whiteboard markers. This is a valuable collaboration tool used by participants.

In certain instances, there is a need for people who are physically unable to be in the meeting room or conference center to be able to participate remotely. There are a plurality of remote online meeting solutions that can effectuate this process. Further, during these meetings where one or more participants are remotely located, it is desirable for them to be able to view what is being written on the writing surface to feel as though they are part of the collaboration. Tools such as electronic whiteboards which digitize written information exist to allow this to occur but they are expensive and difficult to integrate with IT networks. Other mechanism such as image capture systems also exist which allow for an image capture device to capture an image of the writing surface and transmit those images to the remote users. However, in a remote meeting scenario, where a single camera is used to display the meeting room, remote users usually have difficulty in viewing/reading the contents of a whiteboard shown by the single camera. A possible solution for the problem would be an addition of a dedicated camera that focus on the whiteboard, incurring in additional cost in the meeting room set up for remote meetings. A system and method according to the present disclosure remedies the drawbacks identified above.

### SUMMARY

An image processing apparatus is provided and includes one or more processors and one or more memories storing instructions that, when executed, configures the one or more processors, to receive a captured video from a camera capturing a meeting room, extract and store a predefined region of the video as extracted image data, generate a first corrected image by performing first image correction processing on the extracted image data to correct noise and generate a binary mask of the first corrected image, generate a filtered image based on the binary mask of the first corrected image and the first corrected image, generate a second corrected image by performing second image correction processing on the filtered image; and perform blending processing that combines the second corrected image with the first corrected image to generate a final corrected image.

In another embodiment, store, in memory, a predetermined number of masks of the first corrected image, compute the average of the stored predetermined number of masks; and generate an average mask, wherein the filtered image is generated using the average mask.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 illustrates the system architecture of the present disclosure.

FIG. 2 illustrates a writing surface according to the present disclosure.

FIGS. 3A-3G illustrates an image processing algorithm according to the present disclosure.

FIG. 4 illustrates the hardware configuration according to the present disclosure.

FIG. 5 illustrates an algorithm executed as part of the image processing algorithm of FIGS. 3A-3G.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples.

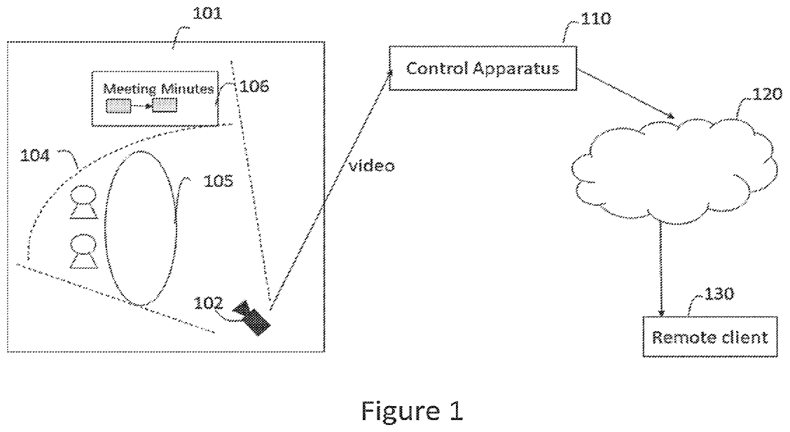

In an online meeting environment where a writing surface such as a whiteboard is being utilized by one or more participants in a meeting room, it is important that those attending the meeting remotely, and thus online, are able to clearly visualize the information being written on the writing surface. One way this is accomplished is using an image capture system such as a camera that can capture high resolution video image data of the writing surface so that those images can be communicated via a network to the remote participants for display on a computing device such as a laptop, tablet, and/or phone. However, in an exemplary environment as shown in FIG. 1 below, where there is a single image capturing device configured to capture a wide view of the entire meeting room space, it may be particularly difficult to obtain an image of the writing surface that is sufficient quality for the remotely located meeting participants. Whiteboard images extracted from images captured by a camera that shows an entire room are very difficult to read due to noise, lighting effects and keystone issues. In order to improve the readability of whiteboards, captured in such an environment (without the addition of a dedicated camera for whiteboard), the below described system and method advantageously obtains high quality images of the writing surface which is extracted from a wide view of the meeting area for transmission to a remote user such that an enhanced image of the writing surface can be transmitted to the remote user using a separate data stream than a data stream that contains the full wide view of the meeting environment. In one embodiment, the transmission of the enhanced whiteboard image may occur via a different transmission channel than a channel that communicates the video images of the entire meeting area.

FIG. 1 illustrates a system architecture according to an exemplary embodiment. The system according to the present disclosure is deployed in a meeting room 101. The meeting room 101 may be a conference room or the like. However, this is not limited to being in a single dedicated room. The system may be deployed in any defined area so long as the components shown in FIG. 1 are able to be included and operate as described below. The meeting room 101 includes a participant area 105 whereabout one or more participants can sit or otherwise congregate and engage in information exchange. As illustrated herein, the participant area includes a conference table and chairs occupied by two in-room meeting participants. This is shown for purposes of example only and the setup can be any type of setup that allows in-room participants to congregate and engage in information exchange. The meeting room 101 also includes a writing surface 106 upon which one or more participants present in the room are able to write information thereon for other participants to view. In one embodiment, the writing surface is a whiteboard that can accept writing using erasable markers. The system further includes an image capture device 102 (e.g. a camera configured to capture video image data or a series of still images in succession such that playback, of individual still images appear as if the image data is video image data) that is provided and positioned at a defined location within the meeting room such that the image data captured by the image capture device 102 represents a predefined field 104 (shown as the area between the hashed lines in FIG. 1.) of view of the room. In one embodiment, the predefined field of view includes the participant region 105 and the writing surface 106. The image capture device is configured to capture, in real time, video data of the meeting room by generating a full room view of everything within the predefined field of view 104. This real-time captured video data is referred to as the in-room data stream.

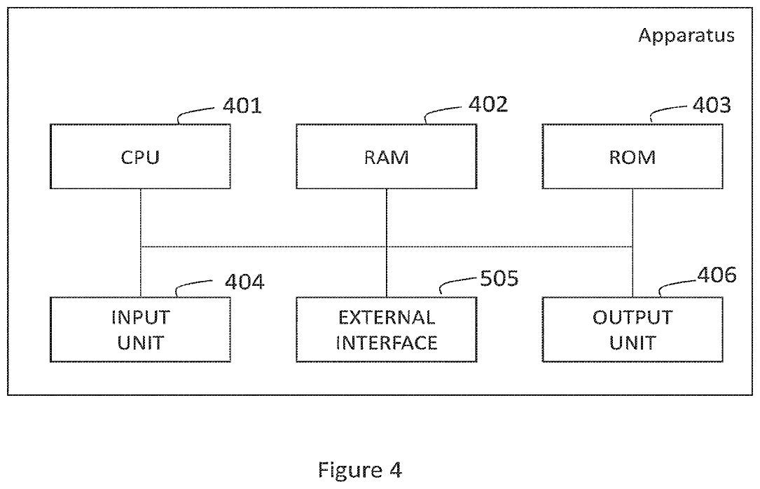

The image capture device 102 is controlled to capture the in-room data stream by a control apparatus 110. The control apparatus 110 is a computing device that may be located locally within the meeting room or deployed as a server that is in communication with the image capture device 102. The control apparatus 110 is hardware as described herein below with respect to FIG. 4. The control apparatus executes one or more sets of instructions stored in memory to perform the actions and operations described hereinbelow. In one embodiment, the control apparatus 110 is configured to control the image capture device 102 to capture the in-room video image data representing the field of view 104 in FIG. 1. This control is performed during a meeting occurring between the in-room participants and one or more remote participants that are connected and viewing the video data being captured by the image capture device 102. According the present disclosure, an algorithm for enhancing a predetermined region of the in-room video data that is being captured in real time is performed. This predetermined region to be enhanced includes the writing surface and areas therearound.

The control apparatus 110 is further configured to transmit video image data representing the real time in-room video via a communication network 120 to which at least one remote client using a computing device 130 is connected. In one embodiment, the communication network 120 is a wide area network (WAN) or local area network (LAN) that is further connected to a WAN such as the internet. The remote client device 130 can selectively access the in-room video data using a meeting application that controls an online meeting between participants in the room 101 and the at least one remote client device 130. The remote client device 130 may used a defined access link to obtain at least the in-room video data captured by the image capture device 102 via the control apparatus 110. In one embodiment, the access link enables the at least one remote client device 130 to obtain both the in-room video data and the predetermined region of the in-room video data that has been enhanced according to the image processing algorithm described hereinbelow.

In exemplary operation, the present disclosure advantageously enhances the writing surface 106 (e.g. whiteboard image) by selecting writing surface area on which a first image correction is performed to generate and store in memory, a first corrected image. In one embodiment, the first image correction is a keystone correction. Thereafter, a mask is computed based on the first corrected image and stored in a mask queue in memory which is set to store a predetermined number (which is configurable) of computed masks. When the Mask Queue is full, the oldest mask is dropped and new one is added to the end of the queue. A computed mask image that is used in performing the remaining image enhancement on the writing surface is computed based on all the masks in Mask Queue at a given time. The purpose of this process is to reduce the variation due to noise/compression across consecutive frames. Finally, the mask is applied to the first corrected image to filter out unwanted artifacts and generates a second corrected image on which color enhancement is applied thereby generating a third corrected image. This algorithm which is realized by one or more processors (CPU 501) of the control apparatus 103 reading and executing a pre-determined program stored in a memory (ROM 503) is described in greater detail below.

An exemplary image processing algorithm that improves the visual look of a predetermined region of a video data stream that is extracted therefrom and which performed by one or more processors that executes a set of stored instructions (e.g. a program) is described below. In one embodiment, the predetermined region includes a writing surface. The exemplary algorithm is as follows includes obtaining information representing predetermined corner positions of the writing surface to be corrected. These corner positions may be input via a user selection using a user interface whereby the user selects corner positions therein. In another embodiment, the writing surface (whiteboard, is automatically detected using known white board detection processing. For example, a user may view the in-room image that shows field of view 104 and identify points representing the four corners of the whiteboard. This may be done using an input device such as a mouse or via a touchscreen if the device displaying the video data is capable of receiving touch input.

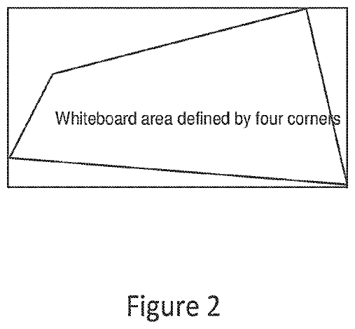

Thereafter, a first image correction processing is performed on the data extracted from the region identified above. The first image correction processing is keystone correction on the whiteboard area based on the 4 defined corners in order to compute the smallest rectangle that will contain the 4 corners as shown in FIG. 2

The perspective transform is computed using the four user-defined corners as source and four corners of the computed rectangle as the target. The perspective transform calculates from four pairs of the corresponding points whereby the function calculates the 3×3 map_matrix of a perspective transform in Equation (1) so that:

$$( \begin{matrix}{t}_{i} {x}_{i}^{′} \\ {t}_{i} {y}_{i}^{′} \\ {t}_{i}\end{matrix} ) = map\_matrix \cdot ( \begin{matrix}{x}_{i} \\ {y}_{i} \\ 1\end{matrix} ) \qquad ( 1 )$$

where src represents the 4 corners defined and dst represents the 4 corners for the smallest rectangle according to the following equation

$$dst ( i ) = ( {x}_{i}^{′} , {xy}_{i}^{′} ) , src ( i ) = ( {x}_{i} , {y}_{i} ) , i = 1 , 2 , 3 , 4 \qquad ( 2 )$$

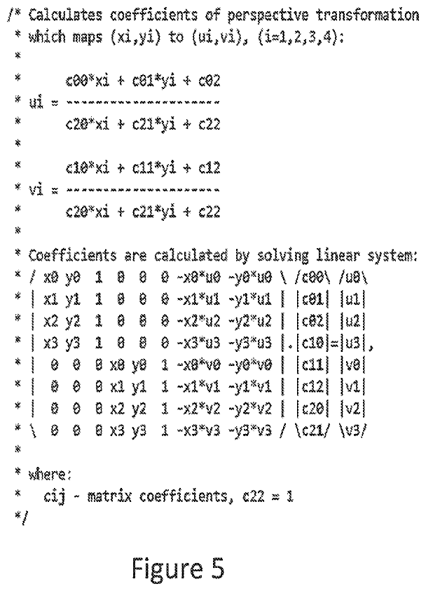

The algorithm obtains coefficients of the map_matrix (Cᵢⱼ) which is computed according to the algorithm illustrated in FIG. 5. Upon obtaining the map_matrix values, a perspective transformation is applied using the inverse of the map_matrix transform computed in the whiteboard source image to obtain the keystone corrected whiteboard image (KC Image). The perspective transformation transforms the source image using the specified matrix in equation 3:

$$dst ( x , y ) = src ( \frac{{C}_{00} x + {C}_{01} y + {C}_{03}}{{C}_{20} x + Cy + {C}_{22}} , \frac{{C}_{10} x + {C}_{11} y + {C}_{12}}{Cx + {C}_{21} y + {C}_{22}} ) \qquad ( 3 )$$

A binary mask is created to filter out noise/illumination artifacts where the threshold value is the mean of neighborhood area. The KC Image is converted to grayscale and adaptive thresholding is applied to the grayscale image to create the binary mask. Adaptive thresholding is a method where the threshold value is calculated for smaller regions and therefore, there will be different threshold values for different regions). In one embodiment, the threshold value is the mean of neighborhood area and pixel values that are above the threshold are set to 1 and pixels values below the threshold are set to 0 (for example, the neighborhood area is a block/neighborhood size of 21). The created mask is added to a queue of masks.

Using the masks in the queue of masks, an updated binary mask is created whereby, for each pixel in the updated binary mask, the pixel value is determined such that, if sum of values for that pixel in all the masks in queue is greater than or equal to the number of masks in queue divided 2, the pixel value in the updated mask is set to 1 (enabled). Otherwise the pixel value is set to 0. The calculation performed for each pixel in the updated mask is performed using Equation 4:

$${m}_{xy} = int ( \frac{{\sum }_{q = 0}^{N} {p}_{xy}^{q}}{int ( \frac{N}{2} )} ) \qquad ( 4 )$$

where N is the number of masks in the queue, p_{xy}^{q} is the value for a respective pixel (x,y) for mask q, that value being 0 or 1, and m_{xy} is the value of the pixel (x,y) in the final mask.

Next, the saturation and intensity are adjusted based on user configuration to adjust for more or less color saturation/intensity. This adjustment is performed for each pixel in KC Image while applying updated binary mask. To do this, the image color space is converted from RGB to HSV in order to adjust saturation and intensity values. Once converted, for all pixels in HSV Image, if mask value for the pixel is 1 (enabled), the pixel S value is updated using the configured saturation setting and the pixel V value is with the configured intensity setting. On the other hand, if mask value in pixel in 0 (disabled), then the pixel is set to white HSV value (0,0,255). Once the settings for each pixel in the HSV image are applied, the HSV Image back to RBG color space as an updated RGB image. An alpha blend is applied the updated RGB image using the KC Image (background). The alpha value for blending is configurable which advantageously enables control as to how strong the unfiltered frame will be merged to the filtered frame. For example, if the alpha value was configured as 0, only the filtered frame will be visible whereas if the alpha value is configured as 1 only the unfiltered frame will be visible. This allows the user to configure the blending that will ultimately be performed. The following computation in Equation 5 is applied for each pixel in result image (p^{r}) using the updated RGB image (p^{u}) with the KC Image (p^{kc}) in order to return the resulting updated RGB image.

$${p}_{xy}^{r} = α * {p}_{xy}^{u} + ( 1 - α ) * {p}_{xy}^{kc} \qquad ( 5 )$$

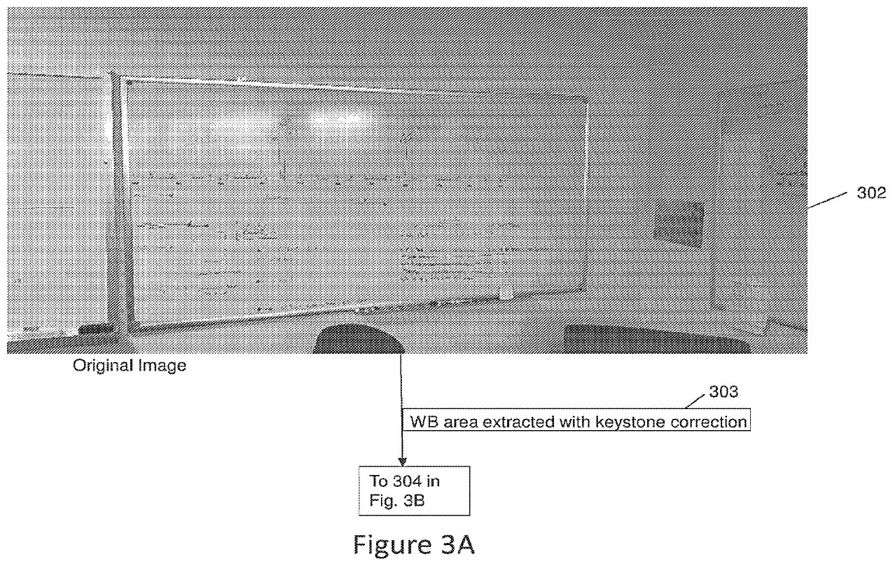

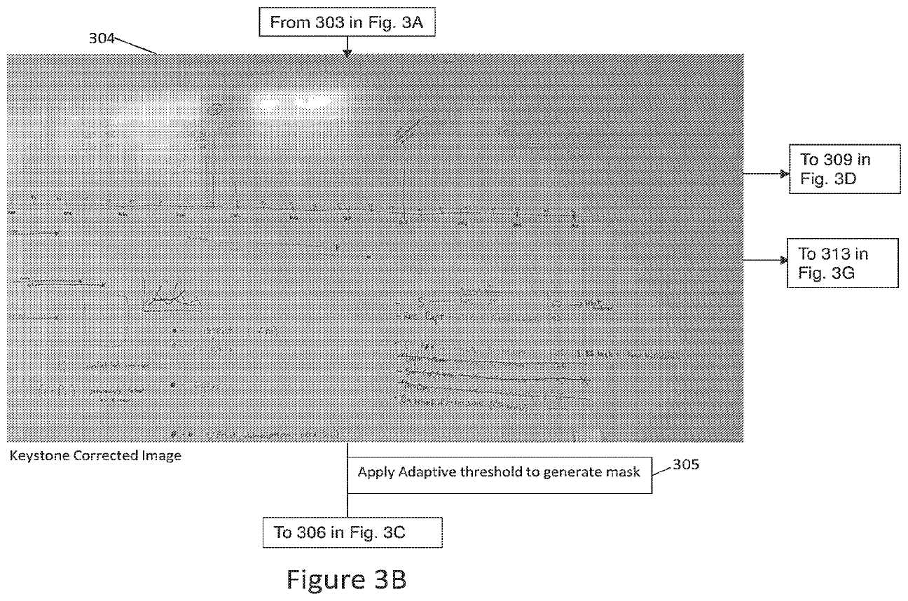

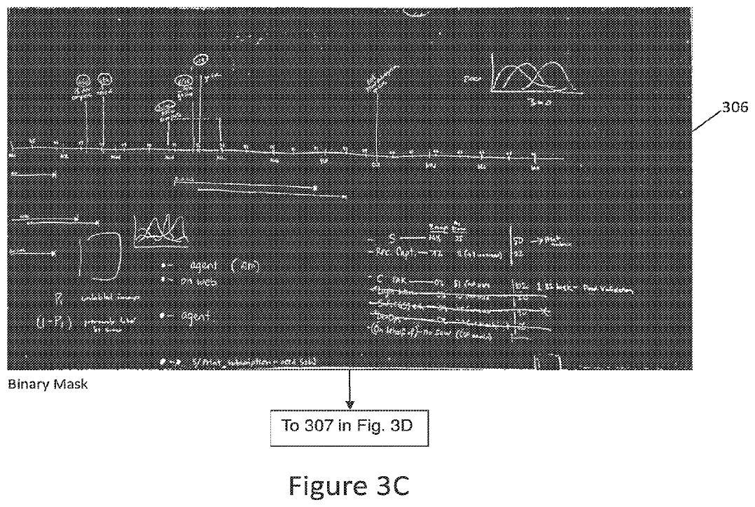

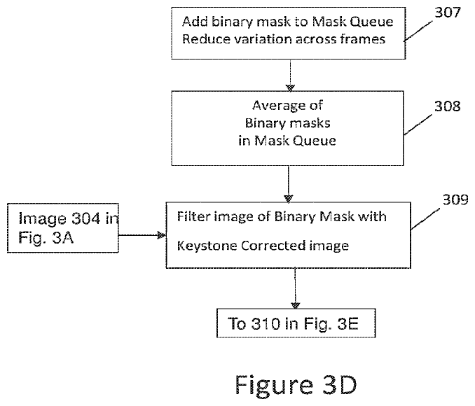

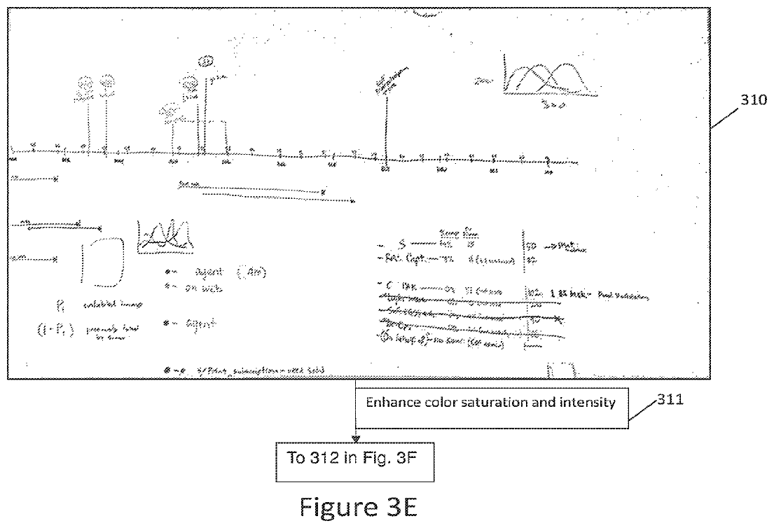

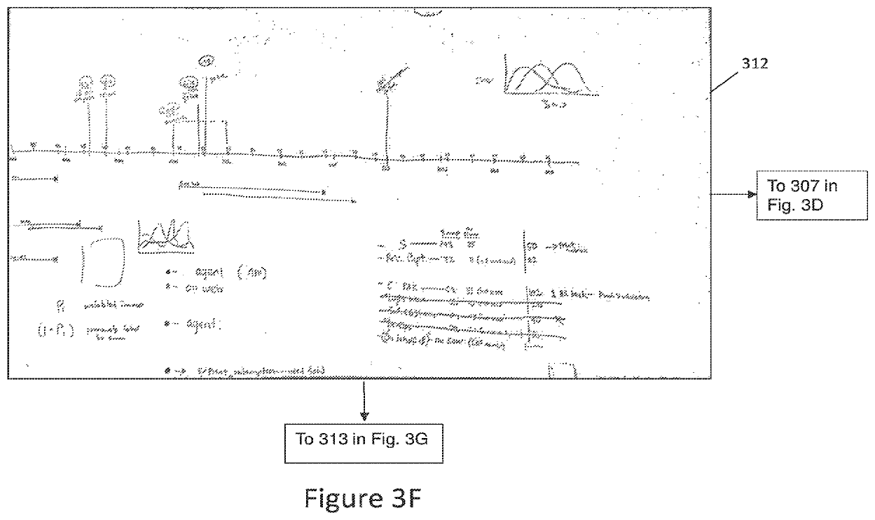

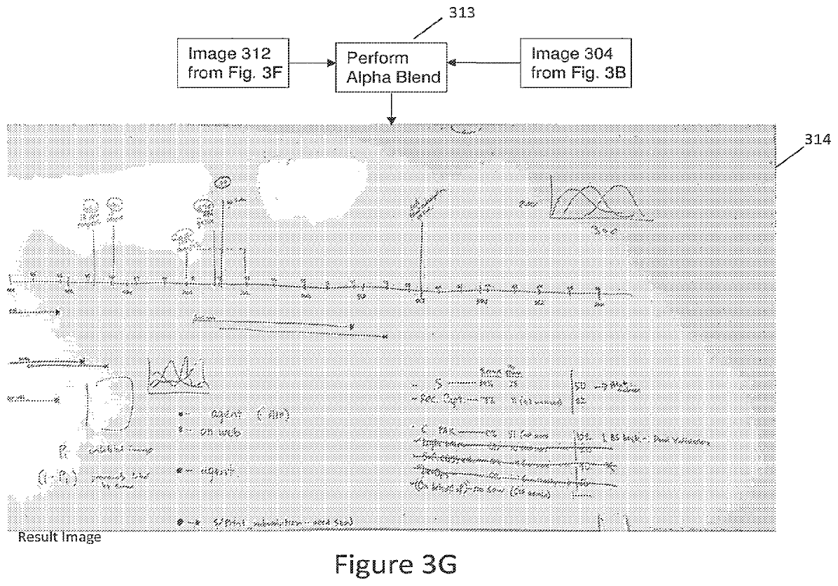

FIGS. 3A-3G is an illustrative flow diagram of the algorithm described above and will be described with respect to components in FIG. 1 that perform certain of the operations. The description and examples shown herein implement the algorithm described above. In 302, the control apparatus 110 causes video image data to be captured by the image capture device 102 that captures an image representing the field of view 104. While the whole field of view 104 is captured and includes the participant area 105 and the writing surface 106, image 302 in FIG. 3A depicts a region that surrounds the writing surface 106. As shown herein, the writing surface is identified based on four points that were selected by the user in advance and is based on the position of the camera. As such, the writing surface region is predefined and set for all instances that the image capture device is capturing the field of view 104 of meeting room 101. In other embodiments, a writing surface detection process can be performed thereby enabling the image capture device 102 to be moved about into different positions within the meeting room and the writing surface region may still be detected and processed as described below.

In 303, the writing surface region is extracted from image 302. The extracted writing surface region is defined using the points identified in image 302 whereby the points are positioned at respective corners of the writing surface. First image correction processing 303 is performed on the extracted writing surface region and generates a first corrected image 304 in FIG. 3B. In one embodiment, the first correction processing is a keystone correction process that generates a clear rectangular image. The first corrected image 304 in FIG. 3B is stored in memory and used as follows. A copy of the first corrected image 304 undergoes mask processing in 305 which applies adaptive thresholding techniques to generate a binary mask image 306 shown in FIG. 3C. Because the image processed described herein is performed using video data, additional image frames are provided as time continues and mask processing is performed on each extracted writing surface region in each frame. For each received image frame, a new mask 306 is generated and a series of generated masks is added to a mask queue in 307 in FIG. 3D. The mask queue represents a series of binary masks at individual points in time based on the video frame rate. The mask queue is set in advance so that a predetermined number of masks are stored therein so that these binary masks can be averaged and generate an average mask image in 308 in FIG. 3D. In 309, in FIG. 3D, the average mask image is filtered together with the first corrected 304 from FIG. 3A, a copy of which still remains in memory. The filtering in 309 generates a second corrected image 310 in FIG. 3E and is based on combining the first corrected image with the average mask image obtained from the mask queue.

The second corrected image 310 in FIG. 3E undergoes second image correction processing in 311 that corrects color and intensity of the second corrected image 310. The result of the second image correction processing 311 generates a third corrected image 312 in FIG. 3F which has been keystone corrected and has been filtered to remove light glare and other artifacts from the original image 302. The third corrected image is provided to 313 in FIG. 3G which performs alpha blend processing using the third corrected image 312 and a copy of the first corrected image 304 from FIG. 3B which has been stored in memory. Alpha blend processing 313 causes a final corrected image 314 to be generated. The final corrected image 314 is then obtained by the control apparatus 110 and is transmitted via network 120 for receipt and display on the remote client computing device 130.

In operation, the above algorithm is performed in real time as new video image data representing the in-room video stream is received by the control apparatus 110. During the online meeting the in-room video stream is transmitted over a first communication path (e.g. channel) in a first format and caused to be displayed on a display of the remote computing device. The extracted region representing the writing surface is not transmitted in the same first format. Rather, as the above algorithm extracts data from video frames, the enhanced writing surface region is transmitted in a second format. In one example, the second format is still image data transmitted at particular rate so that the transmitted enhanced writing surface region appears as video but is actually a series of sequentially processed still images which are communicated to the remote client device over a second, different communication path (channel). This advantageously enables the control apparatus to cause simultaneous display of both the live video data captured by the image capture device and an enhanced region that is generated in accordance with the algorithm described herein of that video data. The algorithm advantageously creates a binary mask based on the keystone corrected image (based on a number of past masks) to filter out noise and then performs saturation and intensity enhancements after applying the mask to the original image in order to alpha blend the keystone corrected image and enhanced image to produce final result.

FIG. 4 illustrates the hardware that represents the control apparatus 110 that can be used in implementing the above described disclosure. The apparatus includes a CPU 401, a RAM 402, a ROM 403, an input unit, an external interface, and an output unit. The CPU 401 controls the apparatus by using a computer program (one or more series of stored instructions executable by the CPU 401) and data stored in the RAM 402 or ROM 403. Here, the apparatus may include one or more dedicated hardware or a graphics processing unit (GPU), which is different from the CPU 401, and the GPU or the dedicated hardware may perform a part of the processes by the CPU 401. As an example of the dedicated hardware, there are an application specific integrated circuit (ASIC), a field-programmable gate array (FPGA), and a digital signal processor (DSP), and the like. The RAM 402 temporarily stores the computer program or data read from the ROM 403, data supplied from outside via the external interface, and the like. The ROM 403 stores the computer program and data which do not need to be modified and which can control the base operation of the apparatus. The input unit is composed of, for example, a joystick, a jog dial, a touch panel, a keyboard, a mouse, or the like, and receives user's operation, and inputs various instructions to the CPU 401. The external interface communicates with external device such as PC, smartphone, camera and the like. The communication with the external devices may be performed by wire using a local area network (LAN) cable, a serial digital interface (SDI) cable, WIFI connection or the like, or may be performed wirelessly via an antenna. The output unit is composed of, for example, a display unit such as a display and a sound output unit such as a speaker, and displays a graphical user interface (GUI) and outputs a guiding sound so that the user can operate the apparatus as needed.

The scope of the present invention includes a non-transitory computer-readable medium storing instructions that, when executed by one or more processors, cause the one or more processors to perform one or more embodiments of the invention described herein. Examples of a computer-readable medium include a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can also be supplied to the computer-readable storage medium by being downloaded via a network.

The use of the terms “a” and “an” and “the” and similar referents in the context of this disclosure describing one or more aspects of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter disclosed herein and does not pose a limitation on the scope of any invention derived from the disclosure unless otherwise claimed. No language in the specification should be construed as indicating any non-claimed element as essential.

It will be appreciated that the instant disclosure can be incorporated in the form of a variety of embodiments, only a few of which are disclosed herein. Variations of those embodiments may become apparent to those of ordinary skill in the art upon reading the foregoing description. Accordingly, this disclosure and any invention derived therefrom includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A control apparatus that performs image processing, the control apparatus comprising:
one or more processors; and
one or more memories storing instructions that, when executed, configures the one or more processors, to:
receive a captured video from a camera capturing a meeting room;
extract and store a predefined region of the video as extracted image data;
generate a first corrected image by performing first image correction processing on the extracted image data to correct noise and generate a binary mask of the first corrected image;
generate a filtered image based on the binary mask of the first corrected image and the first corrected image;
generate a second corrected image by performing second image correction processing on the filtered image; and
perform blending processing that combines the second corrected image with the first corrected image to generate a final corrected image.

2. The control apparatus according to claim 1, wherein execution of the instructions further configures the one or more processors to:
store, in memory, a predetermined number of masks of the first corrected image;
compute the average of the stored predetermined number of masks; and
generate an average mask, wherein the filtered image is generated using the average mask.

3. The control apparatus according to claim 1, wherein the first image correction processing is keystone correction that generates a substantially rectangular image of the exacted predefined region.

4. The control apparatus according to claim 1, wherein execution of the instructions further configures the one or more processors to:
store, in memory, a copy of the first corrected image; and
prior to performing the blending processing, retrieving the stored copy of the first correct image.

5. The control apparatus according to claim 1, wherein the second image correction processing corrects color and intensity of the first corrected image.

6. The control apparatus according to claim 5, wherein execution of the instructions further configures the one or more processors to correct the color and intensity of the corrected image by
converting the first corrected image from a first color space to a second color space;
and for each pixel in the first corrected image having a first value, applying a predetermined saturation setting and a predetermine intensity setting; and
for each pixel not having the first value, set the pixel to be white.

7. An image processing method performed by a control apparatus, the method comprising:
receiving a captured video from a camera capturing a meeting room;
extracting and store a predefined region of the video as extracted image data;
generating a first corrected image by performing first image correction processing on the extracted image data to correct noise and generate a binary mask of the first corrected image;
generating a filtered image based on the binary mask of the first corrected image and the first corrected image;
generating a second corrected image by performing second image correction processing on the filtered image; and
performing blending processing that combines the second corrected image with the first corrected image to generate a final corrected image.

8. The method according to claim 7, further comprising:
storing, in memory, a predetermined number of masks of the first corrected image;
computing the average of the stored predetermined number of masks; and
generating an average mask, wherein the filtered image is generated using the average mask.

9. The method according to claim 7, wherein the first image correction processing is keystone correction that generates a substantially rectangular image of the exacted predefined region.

10. The method claim 7, further comprising:
storing, in memory, a copy of the first corrected image; and
prior to performing the blending processing, retrieving the stored copy of the first correct image.

11. The method according to claim 7, wherein the second image correction processing corrects color and intensity of the first corrected image.

12. The method according to claim 11, further comprising correcting the color and intensity of the corrected image by
converting the first corrected image from a first color space to a second color space;
and for each pixel in the first corrected image having a first value, applying a predetermined saturation setting and a predetermine intensity setting; and
for each pixel not having the first value, set the pixel to be white.
